(19) United States
(12) Patent Application Publication
(10) Pub. No.: US 2011/0226812 A1
(43) Pub. Date: Sep. 22, 2011

(54) FLUID DISPENSER DEVICE

(75) Inventor: Teng-Huei WANG, Tainan County (TW)

(73) Assignee: YONYU PLASTICS CO., LTD., Tainan County (TW)

(21) Appl. No.: 12/726,123

(22) Filed: Mar. 17, 2010

(51) Int. Cl. B67D 7/78

(52) U.S. Cl. 222/145.1

(57) ABSTRACT

A fluid dispenser device includes an internal cap adapted to cover top open ends of concentric inner and outer containers, and having first and second internal ports fluidly communicated with the top open ends, a conduit unit disposed to be displaceable angularly and axially and including a first conduit fluidly communicated with the first internal port through a first valve seat, a second conduit fluidly communicated with the second internal port through a second valve seat, and first and second valves respectively disposed to engage the first and second valve seats, and a nozzle head engageable and movable with the conduit unit and having first and second nozzles disposed downstream of first and second outlets, respectively. With the displacement of the conduit unit, the first and second valves are movable to respectively disengage from the valve seats to permit dispensing of fluids contained in the containers.

### BACKGROUND OF THE INVENTION

1. Field of the Invention

This invention relates to a fluid dispenser device, more particularly to a fluid dispenser device adapted for mounting at top open ends of coaxially extending inner and outer containers that contain two different fluids.

2. Description of the Related Art

A conventional multichamber fluid dispenser device includes two containers for separately accommodating two different fluids, such as household products, personal care products, etc. Each container has its own nozzle so that the fluids are dispensed simultaneously and are mixed together for use.

Referring to FIG. 1, a conventional multichamber fluid dispenser device 1 is shown to include two containers 100 disposed side-by-side within a deformable, collapsible barrel wall 11. By squeezing the barrel wall 11, fluids in the containers 100 can be squeezed simultaneously out of the containers 100. However, since the squeezing force applied to the barrel wall 11 by the user may not be uniform, the amounts of the fluids dispensed may not be in the right proportion. Moreover, no sealing means is provided to prevent prolonged exposure of the fluids in the containers to air.

### SUMMARY OF THE INVENTION

An object of the present invention is to provide a fluid dispenser device which can be conveniently manipulated to dispense different fluids contained therein in a substantially fixed proportion and which can provide an effective seal for the fluids.

According to this invention, the fluid dispenser device includes an internal cap, a conduit unit, and a nozzle head. The internal cap is adapted to cover top open ends of concentric inner and outer containers, and has first and second internal ports configured to be in fluid communication with the top open ends, respectively, and first and second valve seats disposed respectively on the first and second internal ports. The conduit unit is disposed to be angularly displaceable about an axis, and is axially displaceable along the axis. The conduit unit includes a first conduit having a first outlet and a first communicating port which is fluidly communicated with the first internal port through the first valve seat, a second conduit having a second outlet and a second communicating port which is fluidly communicated with the second internal port through the second valve seat, a first valve disposed on the first communicating port, and a second valve disposed on the second communicating port. The nozzle head includes a skirt disposed to surround the conduit unit and engageable with the conduit unit such that the skirt is angularly and axially movable with the conduit unit, and a head having first and second nozzles which are disposed downstream of the first and second outlets, respectively, and which extend in a same direction. When the conduit unit is angularly and axially displaced from a normal position to a dispensing position, the first valve is displaced from a first engaging position, where the first valve is engaged with the first valve seat to interrupt fluid communication between the first internal port and the first communicating port, to a first disengaging position, where the first valve is disengaged from the first valve seat to permit fluid communication between the first internal port and the first communicating port, and the second valve is displaced from a second engaging position, where the second valve is engaged with the second valve seat to interrupt fluid communication between the second internal port and the second communicating port, to a second disengaging position, where the second valve is disengaged from the second valve seat to permit fluid communication between the second internal port and the second communicating port.

By virtue of the arrangement of the concentric inner and outer containers, fluids contained in the containers can be simultaneously and evenly dispensed when the outer container is squeezed or compressed. Moreover, when the conduit unit is in the normal position, the first and second valves are respectively engaged with the first and second valve seats so as to provide a good sealing effect for the fluids in the containers.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a schematic view of a conventional multichamber fluid dispenser device;

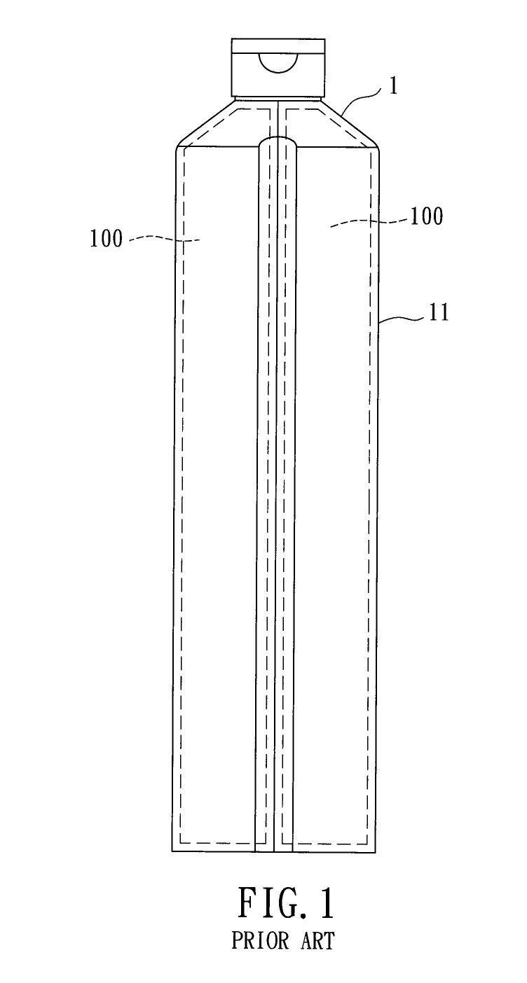

FIG. 2 is a fragmentary perspective view of the preferred embodiment of a multichamber fluid dispenser device according to this invention;

FIG. 3 is an exploded perspective view of the preferred embodiment;

FIG. 4 is a fragmentary sectional view of the preferred embodiment in a closed non-dispensing state;

FIG. 5 is a cross-sectional view of the preferred embodiment in the closed non-dispensing state;

FIG. 6 is a fragmentary sectional view of the preferred embodiment in an open dispensing state; and

FIG. 7 is a cross-sectional view of the preferred embodiment in the open dispensing state.

### DETAILED DESCRIPTION OF THE PREFERRED EMBODIMENT

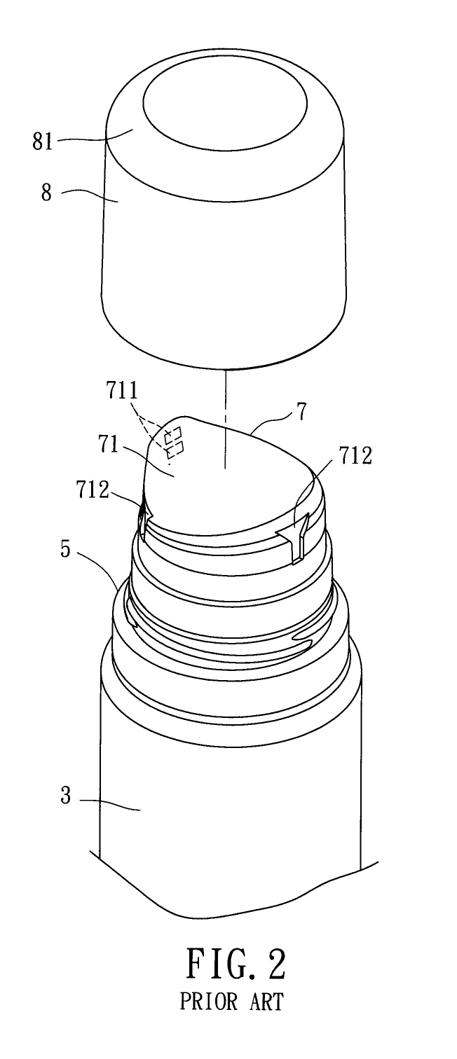

Referring to FIGS. 2 to 4, the preferred embodiment of a fluid dispenser device according to the present invention is adapted to be mounted at an inner top open end 41 of an inner container 4 and an outer top open end 31 of an outer container 3 that coaxially surrounds the inner container 4 along an axis. The inner and outer containers 4,3 are made of a suitable material that is capable of elastic deformation. As shown, the fluid dispenser device according to this invention comprises an internal cap 5, a conduit unit 6, a nozzle head 7, and a manually operable shell 8.

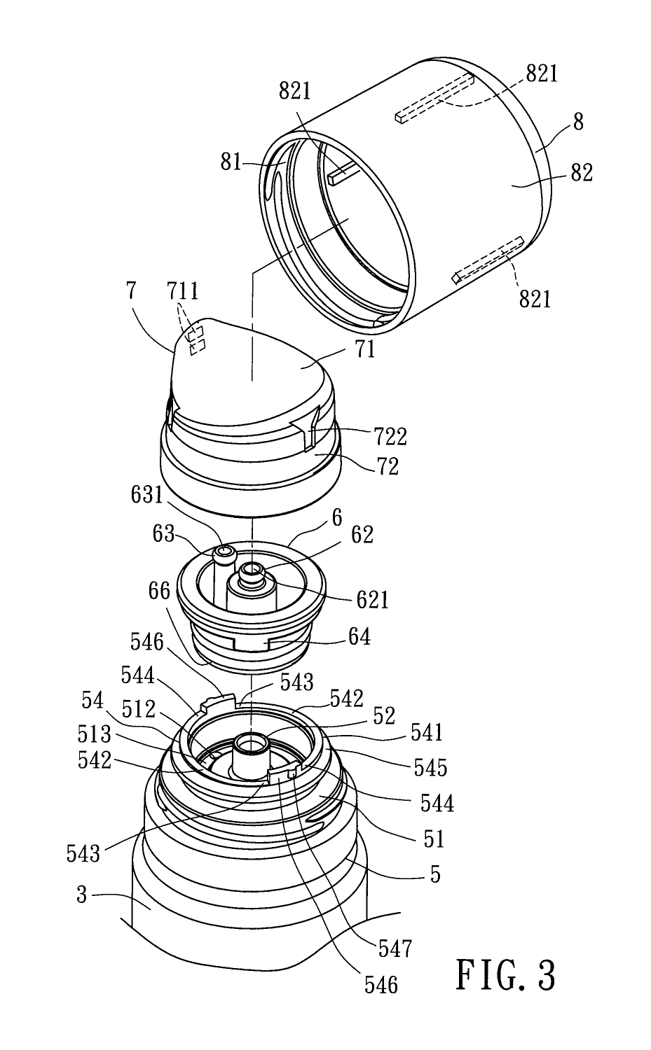

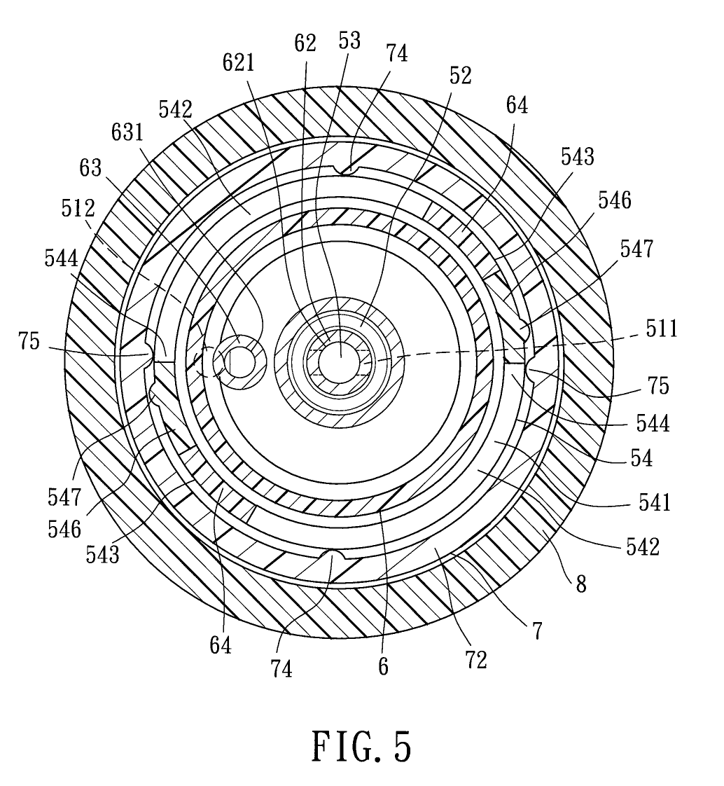

Referring to FIGS. 3 to 5, the internal cap 5 has a major wall 51 adapted to cover the inner and outer top open ends 41,31 of the inner and outer containers 4,3, and a surrounding wall 54 which surrounds the axis and which extends axially from the major wall 51 to terminate at an upper peripheral end 541. The major wall 51 has first and second internal ports 511,512 which are configured to be in fluid communication with the inner and outer open ends, 41,31, respectively, and first and second valve seats 55,513 which are disposed respectively on the first and second internal ports 511,512. Specifically, the first internal port 511 is defined by an axially extending central tubular wall 52. A plug 53 is disposed within and is radially spaced apart from the central tubular wall 52. The central tubular wall 52 and the plug 53 are configured to cooperatively define the first valve seat 55. The second valve seat 513 is disposed to extend in a circumferential direction about the first valve seat 55. In addition, the upper peripheral end 541 defines two guide rail segments 542, each of which is configured to slope upward from a lower area 543 to an upper area 544 in a counterclockwise direction, as viewed from FIG. 5. Further, the internal cap 5 has a surrounding outer flange 545 disposed on the surrounding wall 54 and spaced apart from the major wall 51, two barrier members 546 disposed on the upper peripheral end 541 and respectively ahead of the upper areas 544 of the guide rail segments 542 (i.e., each of the barrier members 546 is disposed at a juncture between the guide rail segments 542), and two resilient protrusions 547 extending respectively and radially from the barrier members 546.

The conduit unit 6 is disposed to be angularly displaceable about the axis, and is configured to be axially displaceable along the axis relative to the internal cap 5 between a normal position and a dispensing position. The conduit unit 6 includes first and second conduits 62, 63, and first and second valves 65, 66. The first conduit 62 has a first communicating port 622 which extends along the axis, and which is disposed downstream of the first internal port 511 such that the first valve seat 55 permits fluid communication between the first internal port 511 and the first conduit 62, and a first outlet 621 disposed downstream of the first communicating port 622. The second conduit 63 has a second communicating port 632 which is disposed radially of the first communicating port 622, and which is disposed downstream of the second internal port 512 such that the second valve seat 513 permits fluid communication between the second internal port 512 and the second conduit 63, and a second outlet 631 disposed downstream of the second communicating port 632. The first valve 65 is disposed on the first communicating port 622, and is engageable with the first valve seat 55. The second valve 66 is disposed on the second communicating port 632, and is engageable with the second valve seat 513. Specifically, the second valve 66 is disposed to extend in a circumferential direction about the first valve 65.

Further, the conduit unit 6 has two riders 64, each of which is disposed to be guided along the respective guide rail segment 542 to move from the respective lower area 543 to the respective upper area 544 when the conduit unit 6 is angularly displaced to the dispensing position.

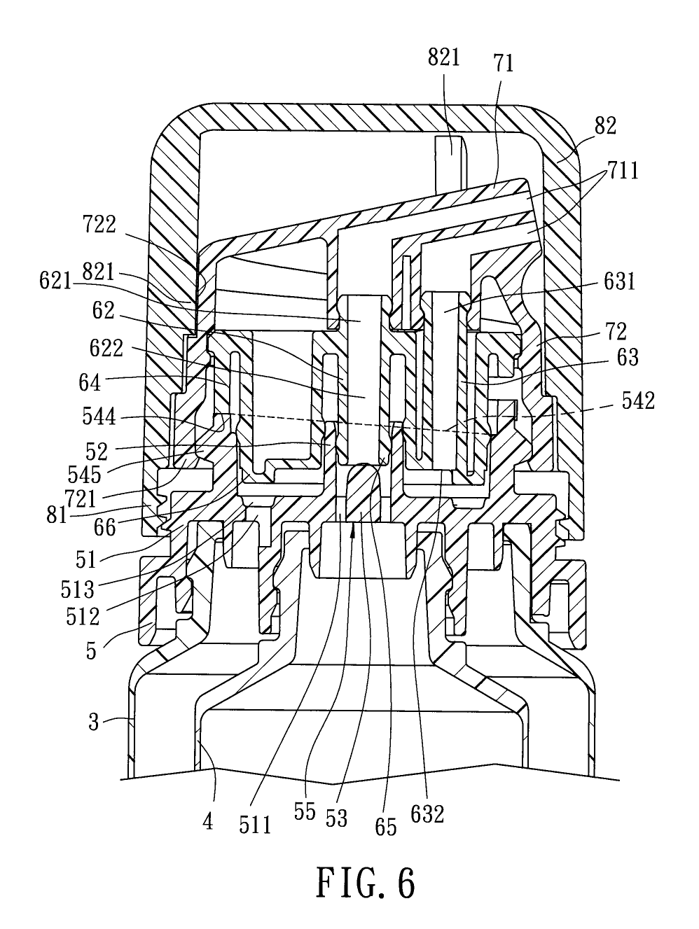

The nozzle head 7 includes a skirt 72 which is disposed to surround the conduit unit 6 about the axis, and which is engaged with the conduit unit 6 such that the skirt 72 is angularly and axially movable with the conduit unit 6 relative to the internal cap 5, and a head 71 which has first and second nozzles 711 that are disposed downstream of the first and second outlets 621,631, respectively, and that extend in a same direction. In addition, the nozzle head 7 has a surrounding inner flange 721 disposed on the skirt 72 to abut against the outer flange 545 when the conduit unit 6 is angularly and axially displaced to the dispensing position so as to prevent removal of the nozzle head 7 from the internal cap 5, as shown in FIG. 6. The nozzle head 7 further has two first limiting protrusions 74 and two second limiting protrusions 75 extending radially from the skirt 72. The first and second limiting protrusions 74,75 are angularly displaced from each other.

The manually operable shell 8 has an internally threaded segment 81 configured to be threadedly engaged with the internal cap 5, and a force transmitting segment 82 configured to be engaged with the skirt 72 of the nozzle head 7 such that the conduit unit 6 is displaceable with a threaded movement of the manually operable shell 8 from the normal position to the dispensing position. In this embodiment, the force transmitting segment 82 has three tongues 821 which are in spline engagement with three grooves 722 in the skirt 72, respectively.

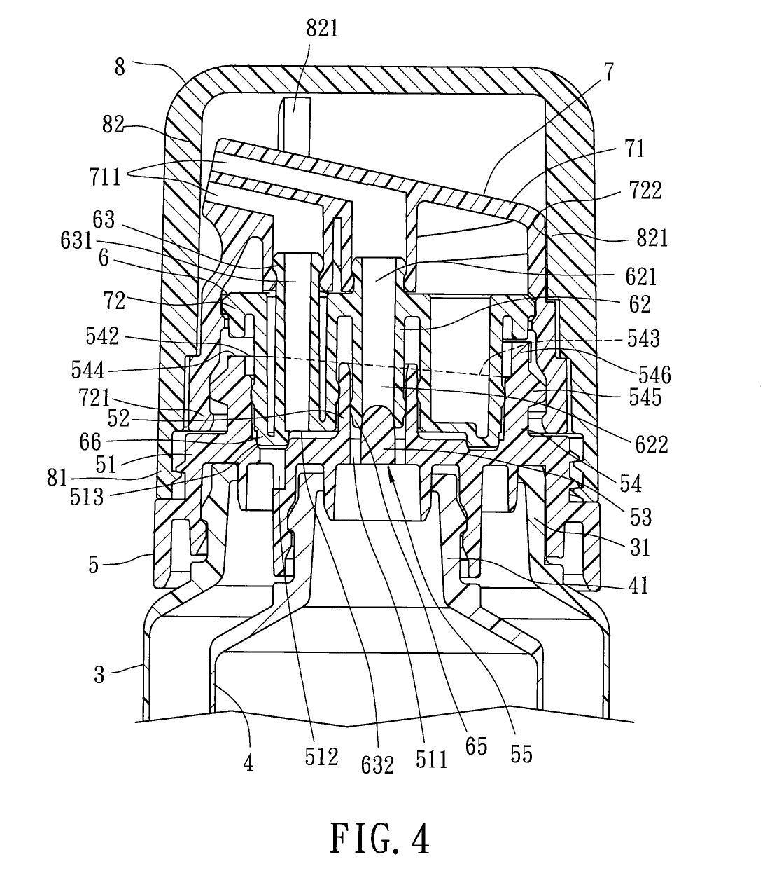

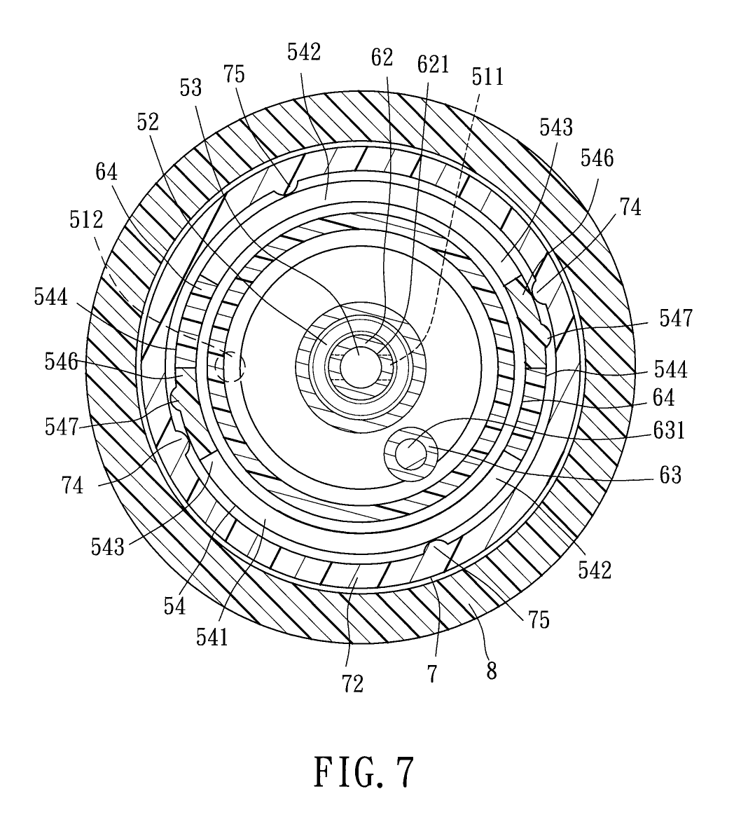

Referring to FIGS. 3, 6 and 7, when it is desired to squeeze the fluids out of the inner and outer containers 4,3, the manually operable shell 8 is screwed-out relative to the internal cap 5 to rotate the nozzle head 7 in the counterclockwise direction, so that the conduit unit 6 is brought to displace angularly and axially from the normal position to the dispensing position. During this displacement of the conduit unit 6, the first valve 65 is displaced from a first engaging position, where the first valve 65 is engaged with the first valve seat 55 (see FIG. 4) to thereby interrupt fluid communication between the first internal port 511 and the first communicating port 622, to a first disengaging position, where the first valve 65 is disengaged from the first valve seat 55 (see FIG. 6) to thereby permit fluid communication between the first internal port 511 and the first communicating port 622, and the second valve 66 is displaced from a second engaging position, where the second valve 66 is engaged with the second valve seat 513 (see FIG. 4) to thereby interrupt fluid communication between the second internal port 512 and the second communicating port 632, to a second disengaging position, where the second valve 66 is disengaged from the second valve seat 513 (see FIG. 6) to thereby permit fluid communication between the second internal port 512 and the second communicating port 632. In addition, during this angular and axial displacement of the conduit unit 6, as shown in FIGS. 5 and 7, the first limiting protrusions 74 are brought to press over the resilient protrusions 547, respectively, to prevent undesired displacement of the nozzle head 7 in a clockwise direction, and the riders 64 are blocked by the barrier members 546 from moving further in the counterclockwise direction. Moreover, the surrounding inner flange 721 on the skirt 72 is raised to abut against the outer flange 545. Subsequently, the manually operable shell 8 is removed, and the outer container 3 can be squeezed or compressed to increase the internal pressure within the inner and outer containers 4,3 so that the fluids can be squeezed out of the containers 4,3.

When it is desired to close the inner and outer top open ends 41,31 of the inner and outer containers 4,3, the manually operable shell 8 is mounted on the nozzle head 7 to permit engagement of the tongues 821 with the grooves 722, respectively, and to permit threaded engagement of the internally threaded segment 81 with the internal cap 5 such that the nozzle head 7 and the conduit unit 6 are angularly and axially displaced in the clockwise direction from the dispensing position to the normal position. Hence, the first and second valves 65, 66 are moved to the first and second engaging positions, respectively. During the angular and axial displacement of the conduit unit 6, the second limiting protrusions 75 are brought to press over the resilient protrusions 547, respectively, to prevent undesired displacement of the nozzle head 7 in the counterclockwise direction, and the riders 64 are blocked by the barrier members 546 from moving further in the clockwise direction.

It is noted that, although, the manually operable shell 8 in this embodiment is provided to be threadedly engaged with the internal cap 5 and to be in splined engagement with the nozzle head 7 so as to enable the nozzle head 7 to be moved with the threaded movement of the manually operable shell 8, the nozzle head 7 may be configured to be manually operable to permit displacement of the conduit unit 6 between the normal position and the dispensing position.

As illustrated, by virtue of the arrangement of the concentric inner and outer containers 4,3, the fluids within the containers 4, 3 can be simultaneously dispensed when the outer container 3 is squeezed or compressed, and the squeezing force applied to the outer container 3 can be evenly transmitted to the inner container 4 so that the amounts of the fluids dispensed are in a substantially fixed proportion. Moreover, since the conduit unit 6 is displaceable with movement of the manually operable shell 8 and the nozzle head 7 between the normal position, where the conduit unit 6 is in a closed non-dispensing state, and the dispensing position, where the conduit unit 6 is in an open dispensing state, the fluid dispenser device of the present invention is convenient to use. Furthermore, since the first and second valves 65,66 are engaged with the first and second valve seats 55,513 when the conduit unit 6 is in the normal position, the fluids can be properly sealed within the containers 3,4.

While the present invention has been described in connection with what is considered the most practical and preferred embodiment, it is understood that this invention is not limited to the disclosed embodiment but is intended to cover various arrangements included within the spirit and scope of the broadest interpretations and equivalent arrangements.

What is claimed is:

1. A fluid dispenser device adapted for mounting at an inner top open end of an inner container and an outer top open end of an outer container that coaxially surrounds the inner container along an axis, said fluid dispenser device comprising:
an internal cap adapted to cover the inner and outer top open ends, and having first and second internal ports which are configured to be in fluid communication with the inner and outer open ends, respectively, and first and second valve seats which are disposed respectively on said first and second internal ports;
a conduit unit disposed to be angularly displaceable about the axis, and configured to be axially displaceable along the axis, said conduit unit including
a first conduit having a first communicating port which extends along the axis, and which is disposed downstream of said first internal port such that said first valve seat permits fluid communication between said first internal port and said first conduit, and a first outlet which is disposed downstream of said first communicating port,
a second conduit having a second communicating port which is disposed radially of said first communicating port, and which is disposed downstream of said second internal port such that said second valve seat permits fluid communication between said second internal port and said second conduit, and a second outlet which is disposed downstream of said second communicating port,
a first valve disposed on said first communicating port, and configured such that, when said conduit unit is displaced from a normal position to a dispensing position as a result of angular and axial displacement thereof, said first valve is displaced from a first engaging position, where said first valve is engaged with said first valve seat to thereby interrupt fluid communication between said first internal port and said first communicating port, to a first disengaging position, where said first valve is disengaged from said first valve seat to thereby permit fluid communication between said first internal port and said first communicating port, and
a second valve disposed on said second communicating port, and configured such that, when said conduit unit is displaced from the normal position to the dispensing position, said second valve is displaced from a second engaging position, where said second valve is engaged with said second valve seat to thereby interrupt fluid communication between said second internal port and said second communicating port, to a second disengaging position, where said second valve is disengaged from said second valve seat to thereby permit fluid communication between said second internal port and said second communicating port; and
a nozzle head including a skirt which is disposed to surround said conduit unit about the axis, and which is engaged with said conduit unit such that said skirt is angularly and axially movable with said conduit unit relative to the axis, and a head which has first and second nozzles which are disposed downstream of said first and second outlets, respectively, and which extend in a same direction.

2. The fluid dispenser device according to claim 1, wherein said internal cap has a major wall which is adapted to cover the inner and outer top open ends and which defines said first and second internal ports and said first and second valve seats, and a surrounding wall which surrounds the axis and which extends axially from said major wall to terminate at an upper peripheral end that defines a guide rail segment that is configured to slope upward from a lower area to an upper area in a counterclockwise direction, said conduit unit having a rider which is disposed to be guided along said guide rail segment to move from said lower area to said upper area when said conduit unit is angularly and axially displaced to the dispensing position.

3. The fluid dispenser device according to claim 2, wherein said internal cap has an outer flange which is disposed on said surrounding wall, said nozzle head having an inner flange which is disposed on said skirt, and which is engaged with said outer flange when said conduit unit is angularly and axially displaced to the dispensing position so as to prevent further upward movement of said nozzle head.

4. The fluid dispenser device according to claim 2, wherein said internal cap has a barrier member which is disposed on said upper peripheral end and ahead of said upper area such that, when said conduit unit is angularly and axially displaced to the dispensing position, said rider is blocked by said barrier member from moving further in the counterclockwise direction.

5. The fluid dispenser device according to claim 4, wherein said internal cap has a resilient protrusion which extends radially from said barrier member, said nozzle head having first and second limiting protrusions which extend radially from said skirt and which are angularly displaced from each other such that, when said conduit unit is angularly and axially displaced between the normal position and the dispensing position, one of said first and second limiting protrusions is brought to press over said resilient protrusion to prevent undesired displacement of said nozzle head.

6. The fluid dispenser device according to claim 1, further comprising a manually operable shell having an internally threaded segment which is configured to be threadedly engaged with said internal cap, and a force transmitting segment which is configured to be engaged with said skirt of said nozzle head such that said conduit unit is angularly and axially displaced with a threaded movement of said manually operable shell.

7. The fluid dispenser device according to claim 6, wherein said force transmitting segment is in spline engagement with said skirt of said nozzle head.

8. The fluid dispenser device according to claim 1, wherein said second valve seat is disposed to extend in a circumferential direction about said first valve seat, and said second valve is disposed to extend in a circumferential direction about said first valve.
